(19) United States
(12) Patent Application Publication
(10) Pub. No.: US 2010/0006347 A1
(43) Pub. Date: Jan. 14, 2010

(54) COVER LENS WITH TOUCH SENSING FUNCTION

(76) Inventor: Kai-Ti Yang, Taoyuan (TW)

Correspondence Address: Kai-Ti Yang, 235 Chung - Ho, Box 8-24, Taipei, TW

(21) Appl. No.: 12/168,913

(22) Filed: Jul. 8, 2008

(51) Int. Cl. G06F 3/041

(52) U.S. Cl. 178/18.01

(57) ABSTRACT

A cover lens with touch sensing function is a transparent plate formed by a substrate, a surface layer, a sensing layer, and an insulated layer. The substrate of the cover lens is a highly transparent plate with outstanding mechanical strength. The surface layer consists of one or a plurality of functional films and is arranged on an upper surface of the substrate. The sensing layer is arranged on a bottom surface of the substrate and further has a plurality of X axis traces and Y axis traces. The X and Y axis traces are formed on the same plane and intersect to each other as a matrix. Induction-spots are formed on each X axis trace and are connected one by one. Induction-spots are formed on each Y axis trace but are formed separately with gaps. Pairs of through holes is formed respectively to all the adjacent induction-spots of each Y axis trace on the insulated layer. A conductive wire crossing between the pair of the through holes is arranged on the surface of the insulated layer. Both ends of the conductive wire exposed to the through holes respectively are formed as electrical joints. The insulated layer is covered on the sensing layer from a bottom surface so as to cover and insulate the X and Y axis traces.

### FIELD OF THE PRESENT INVENTION

The present invention relates to cover lens, and in particular to a cover lens with touch sensing function.

### DESCRIPTION OF THE PRIOR ART

A lot of electronic products such as cell phone, camera, PDA, laptop will be arranged with a cover lens before the Liquid Crystal Display (LCD) equipped on it for the purpose of protecting the screen from being scratched or polluted. Otherwise, for improving the convenience of the input operation, touch panels are widely used with the screen of the electronic products. In practice, the touch panel stacking the cover lens is a most common application used on a screen of the electronic products. For example of a cell phone, the cover lens is usually a transparent thin plate with certain mechanical strength and with thickness about 0.8 to 1.0 mm. On an upper surface of the cover lens, a plurality of functional films will be arranged such as a polarization film, filter film, and scratch-proof film. The thickness of the films is about 0.15 mm. Besides, for example of a capacity touch panel consists of X axis traces, Y axis traces, substrate, and a plurality of insulated layers, the thickness of the assembled touch panel is usually above 1 mm. In addition to the double sides tape for sticking the two components with a thickness about 0.15 mm, the total thickness of the combination of the touch panel and the cover lens will be above 2.3 mm. However, an assembled plate with a thickness over 1.5 mm will cause a structure and appearance design problem, and will also seriously damage the permittivity of the plate. Issues of fuzzy image and gloomy color are occurred. Therefore, to prevent the disadvantages mentioned above, the assembled plate should be made as thin as possible. The cover lens can not be too thin to suffer the impact while being operated. Thus a thinner touch panel is requested and because of the requested thin glass substrate and the thin sensing films, the touch panel is easily failed during the manufacturing processes. The quality of the touch panel is damaged and the production cost is highly raised.

### SUMMARY OF THE PRESENT INVENTION

Accordingly, the primary object of the present invention is to provide a cover lens with touch sensing function. On a bottom surface of the cover lens, a touch sensing structure is formed so that the layers and the thickness of the assembled plate are reduced and the high permittivity and the convenience of installation are maintained. Moreover, the combination of the cover lens and the touch panel can simplify the manufacturing process and also reduce the production cost and raise the production yield.

To achieve above objects, the present invention provides a touch sensing structure on a bottom surface of the cover lens to form a cover lens with touch sensing function. The substrate of the cover lens is a highly transparent thin plate with outstanding mechanical strength such as a glass, polymethylmethacrylate, Polycarbonate, Polythylene terephthalate, or Cyclic Olefin Copolymer. A surface layer is arranged on an upper surface of the substrate. The surface layer has a plurality of functional films such as polarization film, filter film, scratch-proof film, or hard coat layer so that the cover lens has functions of scratch-proofing, anti-reflection, pollution-proofing, glare-proofing, and etched-proofing.

The capacitive touch sensing structure includes at least one sensing layer and one insulated layer. The sensing layer is arranged on a bottom surface of the substrate of the cover lens. The sensing layer is a well conductive and transparent thin film and has a plurality of X and Y axis traces intersecting to each other. Induction-spots are formed on each X axis trace and are connected one by one. Also, induction-spots are formed on each Y axis trace but are formed separately with gaps. An end of each X and Y axis trace is formed as a trace joint. Pair of through holes is formed respectively to all the adjacent induction-spots of each Y axis trace on the insulated layer. A conductive wire is arranged on the surface of the insulated layer and crosses between the pair of through holes. Both ends of the conductive wire exposed to the through holes respectively are formed as electrical joints. The insulated layer is covered on the sensing layer from a bottom surface so as to cover and insulate the X and Y axis traces. On the insulated layer, the electrical joints on both ends of the conductive wire will pass through the corresponding through holes and connect to the adjacent induction-spots of the Y axis trace so that all the induction-spots of each Y axis trace are connected. Ends of each X axis and Y axis trace are respectively connected to sliver conducting wires formed at edges and then conduct to a signal output wire bank. Through above connections, a sensing signal generated by the X axis traces and Y axis traces on the sensing layer is transmitted to a succeeding signal processing circuit through the signal output wire bank.

The insulated layer is preferably made of an insulated and highly transparent material with permittivity about 2 to 4 such as ink or Polythylene terephthalate. The conductive wires of the sensing layer and the insulated layer are made of transparent organic conductive material such as Indium Tin Oxide or Poly ethylenedioxythiophene.

### BRIEF DESCRIPTION OF THE DRAWINGS

FIG. 1 is a perspective exploded view of the components of the present invention.

FIG. 2 is a assembly view partially showing the combination of a insulated layer and a sensing layer of the present invention, and

FIG. 3 is a cross section view along the line E-E of the FIG. 2.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

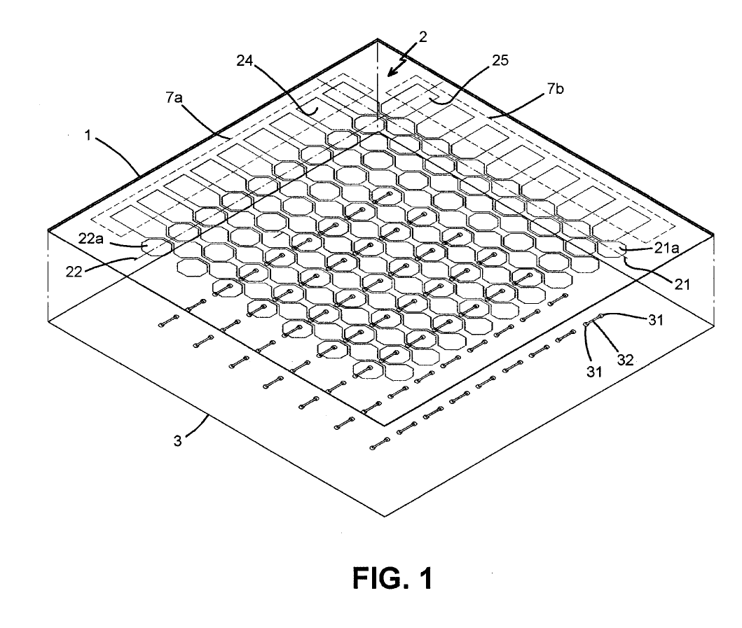

Referring to FIGS. 1 to 3, a preferable embodiment of the present invention is illustrated. The present invention mainly includes a substrate, a surface layer, a sensing layer, and an insulated layer.

The substrate 1 of the cover lens is made of a 0.5 mm polymethylmethacrylate (PMMA) thin plate with permittivity of 95%. A surface layer 12 arranged on an upper surface of the substrate 1 is a hard coat layer with thickness of less than 0.1 mm.

The sensing layer 2 is made of a clear conductive film of Indium Tin Oxide. The sensing layer 2 includes a plurality of transparent X axis traces 21 which are arranged in parallel with fixed interval between, and also includes a plurality of transparent Y axis traces 22 which are arranged in parallel with fixed interval between. The X and Y traces 21, 22 intersect each other as a matrix. Preferably, the widths of the traces 21 and 22 are about 0.05 to 5 mm. Induction-spots 21a are formed on each X axis trace 21 and are connected one by one, and induction-spots 22a are formed on each Y axis trace 22 but are formed separately with gaps. An end of each X axis trace 21 is formed as a trace joint 24, and an end of each Y axis trace 22 is formed as a trace joint 25. The trace joints 24 and 25 can respectively connect to sliver conducting wires 7a and 7b formed at the panel edges near the trace joints 24 and 25 and then conduct to a signal output wire bank (not shown). Through above connections, a sensing signal generated by the X axis traces 21 and Y axis traces 22 on the sensing layer 2 can be transmitted to a succeeding signal processing circuit (not shown) through the signal output wire bank.

The insulated layer 3 is made of an insulated and highly transparent ink film with permittivity about 3. Pair of through holes 31 is formed respectively to all the adjacent induction-spots 22a of each Y axis trace 22 on the insulated layer 3. Each pair of through holes 31 has a conductive wire 32 which is arranged on the surface of the insulated layer 3 and crosses between the through holes 31. Both ends of the conductive wire 32 exposed to the through holes 31 respectively are formed as electrical joints 32a. Preferably, the conductive wire 32 is made of a transparent organic conductive material such as a Poly ethylenedioxythiophene (PEDOT).

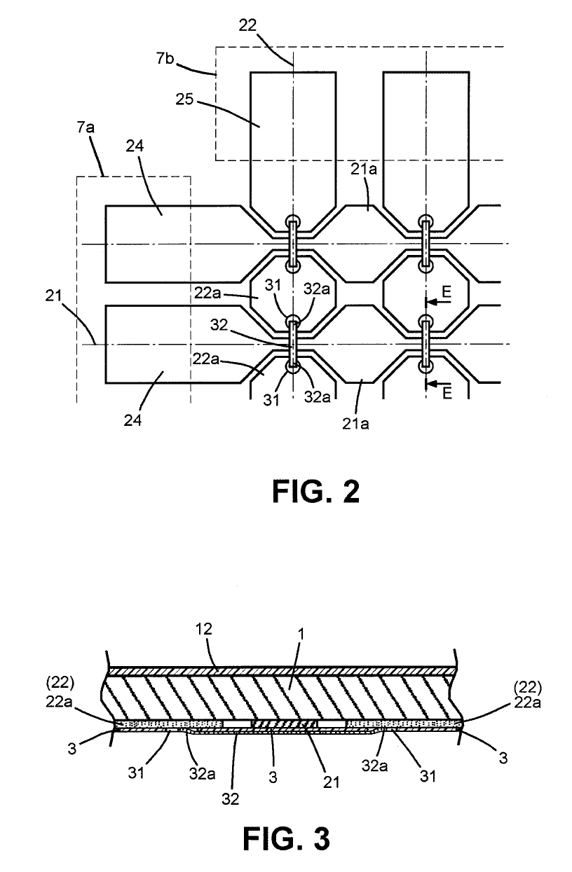

Again with reference to FIGS. 2 and 3, the structure of above components is illustrated. The sensing layer 2 is formed on a bottom surface of the substrate 1, and the insulated layer 3 is covered on the sensing layer 2 from a bottom surface so as to cover and insulate the X axis traces 21 and Y axis traces 22. On the insulated layer 3, the electrical joints 32a on both ends of the conductive wire 32 will pass through the corresponding through holes 31 and connect to the adjacent induction-spots 22a of the Y axis trace 22 so that all the induction-spots 22a of each Y axis trace 22 are connected. Therefore, the X axis traces 21 and Y axis traces 22 are arranged on same surface of the sensing layer 2 and intersect to each other perpendicularly like squares on a chessboard. In the combination of the sensing layer 2 and the insulated layer 3, an equivalent capacity is formed between the X axis trace 21 and the silver conducting wire 7a, and also between the Y axis trace 22 and the silver conducting wire 7b. When a finger or a conductor touches or slides on a certain position on the surface of the touch panel, the signal processing circuit can locate the position by the variation of the capacitance.

Referring to the embodiment of the present invention mentioned above, the thickness of the assembled plate of the cover lens is below 0.7 mm. These light and thin assembled plates are suitable for arranging on a Liquid Crystal Display (LCD) of the electronic products. The cover lens can protect the screen and also a user can easily perform an input by finger touch under the instruction displayed on the screen. Therefore, the present invention uses a cover lens as a substrate of a capacitive sensing device by forming the capacitive sensing components on the bottom side of the cover lens so as to reduce the layers and the thickness. Moreover, the combination of the cover lens and the touch sensing device can also simplify the production procedures, lower the production cost, and raise production yield.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A cover lens with touch sensing function comprising:
a substrate being a highly transparent thin plate with an outstanding mechanical strength;
a surface layer being formed on an upper surface of the substrate and being formed by at least one functional film;
a sensing layer being a transparent film with good conductivity; the sensing layer being arranged on a bottom surface of the substrate; the sensing layer having a plurality of transparent X axis traces which are arranged in parallel with fixed interval between, and also having a plurality of transparent Y axis traces which are arranged in parallel with fixed interval therebetween; the X and Y traces being formed on a same plane and intersecting each other as a matrix; induction-spots formed on each X axis trace being connected one by one and induction-spots formed on each Y axis trace being formed separately with gaps; an front end of each X axis trace and Y axis trace being formed as a trace joint; and
an insulated layer being a transparent insulated film; at least one pair of through holes being formed respectively to all the adjacent induction-spots of each Y axis trace on the insulated layer; a conductive wire being arranged on the bottom surface of the insulated layer and crossing between the pair of through holes; both ends of the conductive wire exposed to the through holes respectively being formed as electrical joints; the insulated layer being covered on the sensing layer from a bottom surface so as to cover and insulate the X axis traces and Y axis traces; on the insulated layer, the electrical joints on both ends of the conductive wire passing through the corresponding through holes and connecting to the adjacent induction-spots of each Y axis trace so that all the induction-spots of each Y axis trace are connected; an end of each X axis and Y axis trace being respectively connected to sliver conducting wires formed at edges and then conducting to a signal output wire bank; through above connections, a sensing signal generated by the X axis traces and Y axis traces on the sensing layer being transmitted to a succeeding signal processing circuit through the signal output wire bank.

2. The cover lens with touch sensing function as claimed in claim 1, wherein the substrate is a thin plate made of glass, polymethylmethacrylate, Polycarbonate, Polythylene terephthalate, and Cyclic Olefin Copolymer.

3. The cover lens with touch sensing function as claimed in claim 1, wherein the functional film is one of a polarization film, a filter film, a scratch-proof film, and a hard coat layer.

4. The cover lens with touch sensing function as claimed in claim 1, wherein the insulated layer is an insulated and highly transparent thin layer with permittivity approximately between 2 to 4.

5. The cover lens with touch sensing function as claimed in claim 4, wherein the insulated and highly transparent thin layer is made of a material selected from ink and Polythylene terephthalate.

6. The cover lens with touch sensing function as claimed in claim 1, wherein the conductive wire is made of transparent organic conductive material.

7. The cover lens with touch sensing function as claimed in claim 1, wherein the conductive wire is a transparent conductive thin film made of Indium Tin Oxide.
